(19) United States
(12) Patent Application Publication
(10) Pub. No.: US 2010/0092272 A1
(43) Pub. Date: Apr. 15, 2010

(54) APPARATUS AND METHOD FOR TRANSFERRING PART LOADS

(75) Inventors: Wolfgang Echelmeyer, Osterholz-Scharmbeck (DE); Hermann Franck, Ritterhude (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/520,953

(22) PCT Filed: Dec. 28, 2007
(86) PCT No.: PCT/EP2007/011441

§ 371 Date: Oct. 6, 2009

(30) Foreign Application Priority Data
Dec. 29, 2006 (DE) 10 2006 062 528.5

(51) Int. Cl. B65G 61/00; B25J 9/00; B65G 47/90; B25J 15/00; B25J 15/06

(52) U.S. Cl. 414/591; 414/800

(57) ABSTRACT

There is provided an apparatus for transferring packaged goods from a first position X to a second position Y. An exemplary apparatus comprises at least one gripping device comprising several gripping elements of which at least two can be actuated separately from each other. The exemplary apparatus further comprises a drive that is adapted to move the at least one gripping device in a vertical direction and in at least one horizontal direction. The exemplary apparatus also comprises a controller that is configured according to a fixed scheme, the controller being adapted to sequentially cancel a gripping effect of the gripping elements. The exemplary apparatus additionally comprises a guide element adapted to steer the packaged goods to the second position Y, the guide element comprising a baffle plate placed in a slanted position and having a bottom plate and two side walls that run towards each other in the form of a funnel.

### CROSS REFERENCE TO RELATED APPLICATIONS

Pursuant to 35 U.S.C. §371, this application is the United States National Stage Application of International Patent Application No. PCT/EP2007/011441, filed on Dec. 28, 2007, the contents of which are incorporated by reference as if set forth in their entirety herein, which claims priority to German (DE) Patent Application No. 10 2006 062 528.5, filed Dec. 29, 2006, the contents of which are incorporated by reference as if set forth in their entirety herein.

### BACKGROUND

Various apparatuses and methods with which objects can be transferred from a first position to a second position in an automated manner are known from the state of the art. Particularly in the realm of the order picking involving containers, pallets or other carriers for goods, it has proven to be advantageous to employ robots that can replace the requisite manual work. In addition to loading containers and pallets, these robots can also unload them in an automated process so that packaged goods can be moved from a given transporting device to a new position.

One area of application for robots is the loading and unloading of essentially cuboidal packages containing goods that have been packed in boxes, cartons or film. Postal packages can also be transferred by robots.

Such robots can employ various gripping devices for picking up objects at a first position and for subsequently releasing them at a second position. The gripping devices are normally matched to the properties of the object in question. For example, tong-shaped grippers, pallet jacks in the form of plates or forks as well as suction devices can all be used.

German Preliminary Published Application DE 28 28 860 A1 discloses, for instance, an apparatus for loading and unloading pallets that is of the cantilevered type and that has a gripping head that can be moved in three directions and pivoted around a vertical axis. Thus, a package can be picked up from a conveyor belt and placed precisely onto a pallet positioned next to the conveyor belt. This placement is done by an automation unit that is controlled by a programming matrix. The gripping head can be in the form of a suction device or a fork.

Normally, efforts are aimed at performing the loading and unloading procedure as quickly as possible. In this context, individually picking up and transferring objects accounts for a considerable loss of time so that an apparatus according to the principle put forward in DE 28 28 860 A1 cannot achieve a fast transfer of all of the objects on a pallet. Moreover, individually picking up objects calls for a precise alignment of the object in a pick-up position and/or for a very precise actuation of the gripping device. For this reason, simultaneously picking up several objects is given preference in some areas of application.

In order to allow the removal of the uppermost layer of a stack of objects having the same shape, even when individual positions in the uppermost layer are not filled with objects, European patent specification EP 0 616 962 B1 proposes, for example, a method to detect the number of rows of objects in the uppermost stack layer on a pallet. In this context, sensors with detector cells ascertain where objects are missing and actuate the gripping capability accordingly. This constitutes an effective but very complicated method for picking up several objects.

Furthermore, it is often the case that objects of varying heights are present in one layer and this likewise has to be taken into account during the picking up procedure. This is the case, for example, in the postal sector, where packages of different sizes are transported on a pallet.

In this context, European patent specification EP 0 550 114 B1 discloses an apparatus for simultaneously gripping and moving several objects of different sizes. For this purpose, the apparatus makes use of several suction heads that are lowered onto a layer of objects that are to be picked up. Since the height of the objects can vary, the suction heads are lowered to different degrees so that they can simultaneously pick up the entire layer of objects by applying negative pressure at each suction head. The gripping device is raised and lowered again at another position in order to simultaneously let go of the objects again in that the negative pressure is cancelled. This, however, likewise constitutes a complicated construction involving several sensors and moving parts, thus making the apparatus very prone to malfunction.

It is often the case that an entire layer of objects does not have to be put down elsewhere in its entirety, but rather, that the objects are to be positioned one after the other, for instance, on a conveyor belt so that they can then be transported on the conveyor belt to the next processing station. For this purpose, the objects are normally picked up in rows and put down again in the same rows. This does not allow entire layers to be transferred, but rather, each layer has to be removed one row at a time, which once again translates into a loss of time.

German Preliminary Published Application DE 103 52 279 A1 also discloses an apparatus for handling objects which sequentially aligns and put down the objects that have been picked up. When several objects are picked up, the only gripping elements to be actuated are those that are needed to pick up the regularly or irregularly arranged objects of a layer. This, however, requires sensor information so that individual gripping elements can be specifically actuated. The provision and evaluation of sensor information to determine the dimensions and orientation of each individual object likewise constitute a complicated and malfunction-prone method.

The transfer of an entire layer of objects having different sizes and arrangements in one row has thus not been solved in a satisfactory manner by the state of the art. Especially since the prior-art apparatuses normally involve complex sensor technology, large dimensions and malfunction-prone components.

### SUMMARY OF THE INVENTION

An exemplary embodiment of the present invention relates to a simple and compact apparatus for transferring packaged goods between at least two positions. The apparatus picks up a layer of several objects of different sizes and arrangements from a first position and then puts them down one after the other in a row at a second position.

One exemplary embodiment of the present invention comprises an apparatus that transfers packaged goods from a first position X to a second position Y. The apparatus has at least one gripping device that can be moved by a drive in the vertical direction and in at least one horizontal direction. The gripping device also comprises several grippers, at least two of which can be actuated separately from each other. The apparatus has a controller for sequentially canceling the gripping effect of the gripping elements.

Exemplary embodiments of the present invention may also relate to an exemplary method for transferring packaged goods.

The apparatus according to an exemplary embodiment of the present invention for transferring packaged goods from a first position X to a second position Y may have at least one gripping device that can be moved by a drive in the vertical direction and in at least one horizontal direction. This gripping device comprises several gripping elements of which at least two can be actuated separately from each other. The device also has a controller that is adapted to sequentially cancel the gripping effect of the gripping elements, whereby the controller is configured according to a fixed scheme.

In an exemplary embodiment of the invention, the gripping device comprises at least two rows, each comprising at least two gripping elements. The controller may be configured to cancel the gripping effect of the gripping elements one row at a time.

The gripping elements can be, for instance, clamping devices with which the packaged goods can be picked up, whereby the clamping effect of the clamping devices can be cancelled sequentially. The gripping elements can also be suction devices of which at least two are connected separately from each other to a source of negative pressure, and the device has a controller that is adapted to sequentially cancel negative pressure in the suction devices.

In a preferred exemplary embodiment of the invention, the apparatus has a guide element in order to steer the packaged goods to the second position Y.

This guide element can be, for example, a baffle plate placed in a slanted position and having a bottom plate and two side walls. The side walls preferably run towards each other in the form of a funnel.

In a preferred exemplary embodiment of the invention, the drive is located inside a housing that is arranged above the first position X. The housing can be, for example, a gantry structure and can be formed by at least two essentially vertical side struts and an upper cross strut. It has been proven to be particularly advantageous to have four essentially vertical side struts arranged in a rectangle and four upper cross struts that connect the side struts.

The drive may be, for instance, an articulated-arm robot that is installed on the housing of the apparatus. The articulated-arm robot can be moved in the horizontal direction on a rail. The rail is attached, for example, to at least one upper cross strut of the housing.

In a preferred exemplary embodiment of the invention, the second position Y is located outside of the housing. The guide element is attached to the housing and is likewise located outside of the housing.

In a preferred exemplary embodiment of the invention, the apparatus is mounted on a movable baseplate. The baseplate can have fixtures into which a transporting device can be inserted. The fixtures into which a transporting device can be inserted can be, for example, forklift slots.

In addition, in the first position X, the apparatus can have a device that aligns a carrier such as a pallet or a container on or in which the packaged goods are positioned in order to be picked up.

An exemplary embodiment of the present invention also encompasses a method for transferring packaged goods using the apparatus according to the invention. The method provides for the packaged goods to be picked up by the gripping device at the first position X and for the gripping device to be moved by the drive in the vertical direction and in at least one horizontal direction to the second position Y. At the second position Y, a controller actuates at least two of the gripping elements separately from each other and the gripping effect of the gripping elements is sequentially cancelled according to a fixed scheme. In this process, the packaged goods are preferably moved by the drive to a position Y above a conveyor belt.

The gripping device according to an exemplary embodiment of the present invention comprises at least two rows, each comprising at least two gripping elements. The gripping effect of the gripping elements is preferably cancelled one row at a time. The at least two rows, each comprising at least two gripping elements, preferably extend in the transportation direction of the conveyor belt, and the controller of the device starts the cancellation of the gripping effect of the gripping elements in an outer row and then continue this cancellation one row at a time.

In an exemplary embodiment of the invention, the cancellation of the gripping effect of the gripping elements is synchronized with the advance movement of the conveyor belt.

The apparatus according to an exemplary embodiment of the present invention and the associated method make it possible to simultaneously pick up several packaged items of varying sizes and of different alignments at a first position X and to then put them down one after the other at a second position Y in a simple manner. Therefore, particularly through the use of a conveyor belt at the second position Y, a row of packaged goods can be created from several packaged items that are stacked next to and on top of each other, for instance, on a pallet, and this row of items can be transported away one after the other.

As an alternative, instead of a conveyor belt, any other structure that serves for receiving the packaged goods can be provided at the second position Y. For instance, the objects can be put onto an inclined plane that serves as a feed mechanism to a conveyor. This feed mechanism can distribute the objects onto one or more conveyor belts. The objects can also be placed directly into containers or transportation vehicles that then transport the objects away individually.

With the method according to an exemplary embodiment of the present invention for operating the apparatus, it may not always be possible to simultaneously pick up all of the objects of a layer during a transfer procedure since the packaged goods can be of different heights and, during each transfer procedure, only the objects that are tallest can be picked up. However, by repeating the transfer procedure several times, an entire layer can be removed and thus a pallet can be completely emptied. This approach is far more effective than the individual transfer of the packaged goods and also entails the advantage that as many objects as possible can be transferred at the same time without advance information provided by sensor technology. In this context, the apparatus comprises simple and sturdy components that do not necessitate complicated sensor technology. This is especially advantageous in environments that are very dirty since the apparatus requires less maintenance and its service life is prolonged.

The sequential cancellation of the gripping effect of the individual gripping elements and particularly the row-by-row cancellation of the gripping effect according to a fixed scheme constitute a simple method for putting down several packaged items, and there is likewise no need for complicated and malfunction-prone sensor technology.

The apparatus according to an exemplary embodiment of the present invention can be used in many ways and without requiring time to be retooled; in particular, a mobile unit offers the advantage that it can be positioned at different sites of operation. Except for a power source, no other structural measures have to be provided in order to position the unit somewhere else.

Another advantage of an exemplary embodiment of the present invention lies in the fact that the gripping device and the packaged goods to be unloaded are arranged inside the housing of the apparatus. Consequently, the structural outer dimensions of the apparatus at the same time constitute the safety area that is shielded by the housing of the apparatus. Therefore, if the apparatus is set up as a mobile unit at a given location, there is no need for additional safety bathers in order to shield the moving parts of the apparatus from the surrounding area. The housing only permits the positioning of a container or pallet inside the housing, which can be done in a simple manner, for instance, using a pallet jack or a forklift.

### BRIEF DESCRIPTION OF THE DRAWINGS

The figures show the following:

FIG. 1 is a perspective view of an apparatus according to an exemplary embodiment of the present invention, with packaged goods that have been picked up;

FIG. 2 is a perspective view of an apparatus according to the exemplary embodiment shown in FIG. 1, with packaged goods that have been transferred;

FIG. 3 is a perspective view of an apparatus according to the exemplary embodiment shown in FIG. 1, with packaged goods that have been put down;

FIG. 4 is a side view of another apparatus according to an exemplary embodiment of the present invention;

FIG. 5 is a side view of an arrangement of several suction elements in a gripping device according to an exemplary embodiment of the present invention; and

FIGS. 6a through 6d are successive side views showing the actuation of several suction elements in a gripping device according to an exemplary embodiment of the present invention.

### DETAILED DESCRIPTION OF SPECIFIC EMBODIMENTS

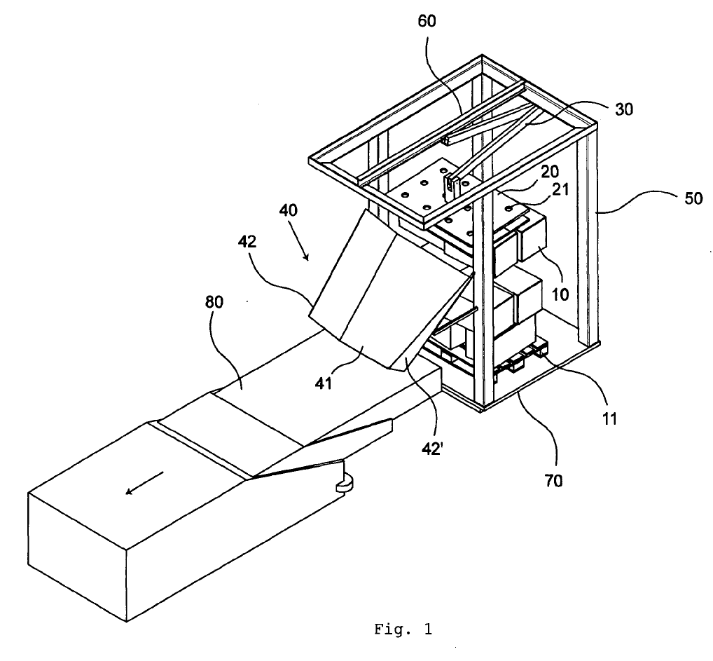

An apparatus according to an exemplary embodiment of the present invention is explained with reference to FIG. 1. This apparatus will be referred to below as a pallet-emptying unit since this apparatus is suitable especially for the automated removal of packaged goods from a pallet and will be explained by way of example with reference to this procedure. The packaged goods to be removed from the pallet can be any goods that can be picked up by a suitable gripping device. The packaged goods can be packed, for example, in cartons, boxes, paper or films, and they are typically cuboidal. The packaged goods can have the same or different dimensions and can be arranged on the pallet regularly or irregularly.

The pallet-emptying unit shown in FIG. 1 comprises a housing 50 in which a drive 30 is arranged. In this exemplary embodiment, the housing is formed by a gantry structure consisting of at least four essentially vertical side struts that are connected to each other at their upper ends by at least four more cross struts. Additional struts can be provided if this is necessary for the stability of the housing. It is also possible to form the housing by a gantry comprising, for instance, of only two side struts and one upper cross strut.

The housing can be configured completely open at the sides, as shown in FIG. 1. However, there can also be side walls between the vertical side struts. It is only necessary for at least one side to be advantageously configured to be open or to have a door so that pallets containing packaged goods can be placed into the apparatus and empty pallets can be removed again. The side opposite from this open side is essentially likewise configured to be open so that the packaged goods can be removed from the housing 50 and transferred to a certain position.

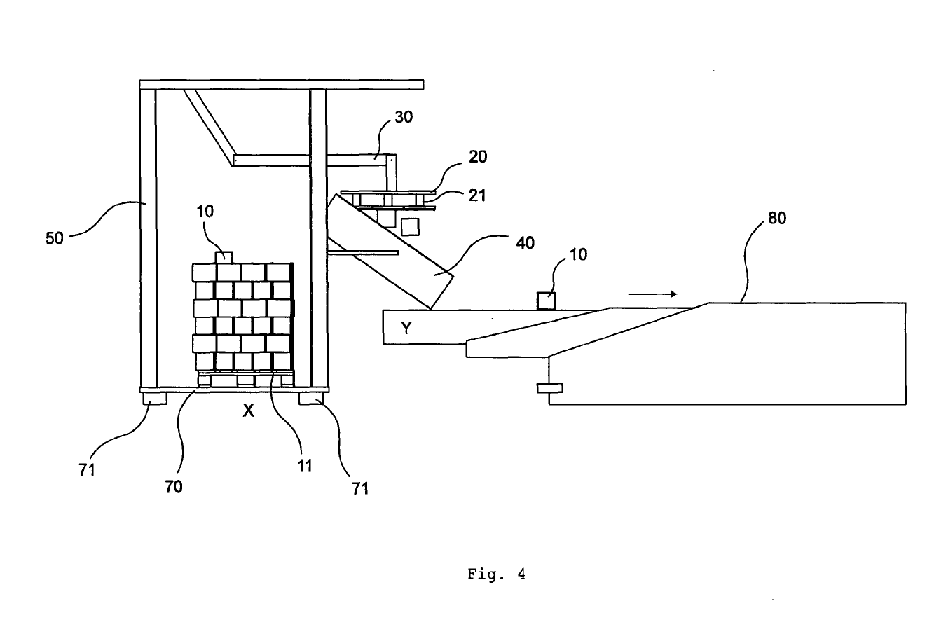

The side struts are preferably attached to a movable baseplate 70 so that the entire apparatus is mobile. For example, the pallet-emptying unit can be picked up by a forklift and moved. For purposes of safe transportation, the baseplate 70 of the apparatus is provided, for example, with forklift slots 71, as can be seen in the side view of the apparatus in FIG. 4.

In an exemplary embodiment of the invention, a rail 60 is affixed to at least one of the side strut or cross strut of the housing 50 and the drive 30 can be moved horizontally along said rail. In the exemplary embodiment of the invention shown in FIG. 1, the rail 60 extends between two upper cross struts. Via the rail, the drive can move horizontally inside the housing 50 that is formed by the structure made up of struts.

The drive 30 is configured, for example, as a multi-axis robot or an articulated-arm robot that is equipped with a gripping device 20. The arms and joints of the articulated-arm robot allow the gripping device to be moved at least vertically. The articulated-arm robot can also be configured in such a way that the gripping device can move not only vertically but also horizontally. In this case, the rail 60 is not necessary at all, or at least only in a shortened form, in order to allow the drive to move horizontally. Such an exemplary embodiment in which an articulated-arm robot moves the gripping device not only vertically but also horizontally is shown in FIG. 4. In this case, the rail 60 is configured as a simple strut to which the articulated-arm robot is affixed.

In another exemplary embodiment of the invention, the drive 30 is configured as a linear guide system in which the gripping device 20 is only moved along the rail 60 and vertically.

The gripping device 20 comprises at least two gripping elements with which packaged goods can be picked up. In an exemplary embodiment of the invention not shown in the figures, the gripping elements are clamping devices with which the packaged goods can be picked up. For instance, two opposing sides of the gripping device are each provided with a movable clamping plate. When the clamping plates are moved towards each other, several packaged items can be clamped between the plates and picked up. In order for the packaged goods to be put down, the clamping plates are moved apart from each other by a control unit or controller.

For purposes of putting packaged goods down sequentially, the sides of the gripping device are provided, for example, with several individual clamping plates that can be actuated pairwise. Thus, the gripping effect of the clamping plates can be cancelled one row at a time, as a result of which the objects held between the clamping plates drop one row at a time.

In a preferred exemplary embodiment of the invention, the gripping device 20 in a plate-like structure has several suction elements 21. At least two of these suction devices are each separately connected to a source of negative pressure (not shown in the figure). This separate connection to a source of negative pressure and the associated control allow a systematic generation and cancellation of negative air pressure at the individual suction devices.

A suction device 21 can have several suction openings 22 for applying a negative pressure onto an object. Therefore, a segment consisting of several suction openings can also be seen as the suction device, whereby this suction device is connected in its entirety to a source of negative pressure. In this context, the multiple suction openings serve to uniformly distribute the negative pressure inside the suction element, and suction openings of different sizes can also be provided.

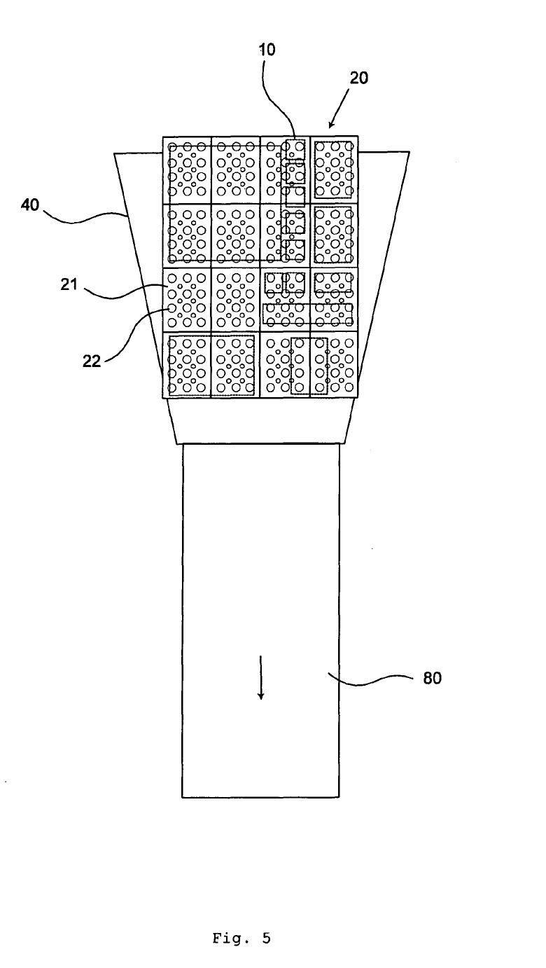

Preferably, several such suction devices 21 are arranged in the form of a matrix on a plate, resulting in at least two rows, each consisting of at least two suction devices. The arrangement of 16 suction segments having several suction openings 22 is schematically depicted in FIG. 5.

The number and arrangement of the suction devices 21 is advantageously adapted to the dimensions of the pallet to be emptied and to the size of the packaged goods to be picked up. The suction devices preferably cover the entire surface area of the pallet so that all of the packaged goods present there can be picked up by suction. The number of suction devices and the size of a suction segment made up of several suction openings 22 are essentially a function of the average size of the packaged goods. If the packaged goods are exclusively very large items, so that a pallet is loaded with just a few objects in one layer, then there is only a need for a few individually actuatable suction devices. If, in contrast, the packaged goods are very small, then a larger number of individually actuatable suction devices is needed in order to sequentially put down these packaged goods.

It can be seen in FIG. 5 that a 4×4 matrix made up of 16 suction segments 21, each consisting of several suction openings 22, is capable of covering a europallet measuring 1200×800 mm (length×width), whereby packaged goods of various sizes can be picked up. The picked-up packaged goods 10 are depicted by broken lines in FIG. 5. Larger packaged goods are simultaneously held by several suction devices 21, while other suction segments can hold several small packaged items. If there are no packaged goods at a given position in a layer or if a packaged item cannot be picked up by suction due to its height, then individual suction elements remain unoccupied. Thanks to the independent connection to the source of negative pressure, however, this does not cause any loss of pressure.

In order to allow pallets having differing loads to be emptied, the gripping device can be replaceable, so that different gripping devices can be used for different requirements.

The pallet-emptying unit can be permanently installed, for example, in front of a conveyor belt 80, with which packaged goods are sequentially transported to a destination. If the apparatus is configured as a mobile unit that can be set up in various places, it can be transported, for example, by a forklift to a conveyor belt, where it can be set up in a defined position. In order to secure the apparatus, anchoring elements can be provided in the floor of the building. If this is not the case, the unit can be configured in such a way that its own weight on the baseplate ensures sufficient stability.

A mobile pallet-emptying unit is preferably configured in such a way that it can easily be connected to a power source at its place of operation. In a practical manner, the apparatus has its own source of compressed air or it generates its own negative pressure, so that only electricity is needed for its operation.

Another feature of the pallet-emptying unit is a guide element 40 with which the packaged goods picked up by the gripping device can be steered to a certain position. In the exemplary embodiment shown in FIG. 1, this guide element is made up of a baffle plate 40 that is installed between two side struts of the housing. The baffle plate consists of a bottom plate 41 and two side walls 42 and 42′ that are inclined downwards and facing away from the pallet-emptying unit. The side walls of the baffle plate can also run towards each other in a funnel-like manner, so that packaged goods that are put down onto the baffle plate slide towards the center of the baffle plate and downwards. This slanted positioning of the baffle plate can be seen particularly well in the side view shown in FIG. 4.

The packaged item 10 that is to be transferred between two positions using the apparatus according to the invention is transported to the apparatus on a transporting device or carrier and placed into the apparatus. The transporting device is, for example, a pallet or a container. The packaged goods are stacked next to each other and above each other in several layers on a pallet. Packaged goods in containers are preferably likewise stacked in several layers so that they can be picked up by the apparatus according to the invention. Since the apparatus according to the invention lends itself especially well for removing packages from pallets, the apparatus will be explained below with reference to this procedure. The packages 10 stacked on the pallet can be of varying sizes so that particularly their heights differ.

A pallet 11 is placed into the housing 50, where it is preferably aligned with one or more stops, so that the pallet assumes a defined position inside the apparatus. From this first position X inside the housing 50, the packaged goods are to be transferred to a second position Y outside of the housing. The pallet is advantageously aligned in such a way that it is situated below the gripping device 20 so that all of the packages 10 can be reached by the suction devices of the gripping device. The horizontal dimensions of the gripping device thus preferably correspond to at least the dimensions of a pallet that is being used. In order to also allow the unloading of containers having side walls, the dimensions of the gripping device are selected such that the gripping device can be lowered into the container.

Once the pallet has been aligned, the pallet-emptying procedure is started. This can be done, for example, by manually triggering a switch in an operating panel. In response, the gripping device is lowered by the drive 30 onto the uppermost layer of packages. As soon as the gripping device has made contact with the uppermost packages, the lowering procedure is braked by Z-compensation and the gripping device is only lowered to such an extent that the gripping device exerts sufficient pressure onto the uppermost packages to be able to pick them up using the negative pressure suction in the individual suction devices 21.

Here, the gripper can be moved towards the uppermost layer in a tactile or contact-free manner by a distance sensor. For this purpose, the gripper has, for instance, a gripper flange with a movement compensation in the Z-direction. The position of the Z-compensation can be queried via a sensor and the gripper can be braked starting at a defined position.

Once the gripping device has been braked at the correct height, negative pressure is applied to the suction devices 21 of the gripping device by the source of negative pressure. As a result, the top packages are held on the plate of the gripping device when the latter is moved vertically upwards by the articulated-arm robot 30, as is depicted in FIG. 1. In this process, only the tallest packages are picked up, whereas smaller packages on the uppermost layer remain on the pallet.

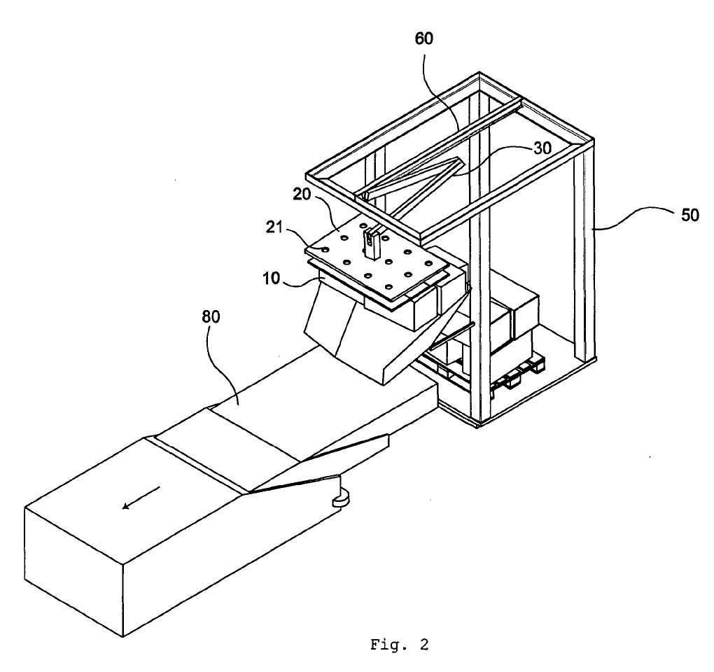

Once the gripping device 20 has reached a defined minimum height, it is moved horizontally together with the drive 30 along the rail 60. The drive is moved until the gripping device and thus the picked-up packages are situated above the baffle plate 40, as is shown in FIG. 2. Towards this end, the baffle plate 40 should be installed at a suitable height that can be overcome by the drive.

In the exemplary embodiment of the invention shown in FIG. 4, the horizontal movement of the gripping device with the picked-up packages 10 is likewise done by the articulated-arm robot, so that there is no need to move the drive along a rail. As an alternative, the horizontal movement can partially take place through angular movements of the articulated-arm robot and by moving the robot on the rail.

In the position of the packages thus reached above the baffle, the negative pressure in the suction devices 21 of the gripping device 20 is sequentially switched off so that the picked-up packages drop onto the baffle plate one after the other. In this process, all of the suction devices can be vented individually or else sections with several suction devices can be vented jointly. The sequential switch-off of the negative pressure, in conjunction with this invention, means that individual suction devices or sections with several suction devices can be vented staggered over time and thus one after the other.

If entire sections of the suction devices are vented and if individual suction devices are holding several small packages, it could happen that several packages drop down at the same time. This, however, is not detrimental to the mode of operation of the apparatus since the packages are guided by the baffle plate 40 onto the conveyor belt one after the other. Particularly in the postal sector, it is likewise not detrimental if several small packages even slide next to each other onto the conveyor belt and are transported away only slightly offset with respect to each other.

According to an exemplary embodiment of the present invention, the gripping effect of the gripping elements is cancelled according to a fixed scheme. In this context, it has proven to be especially advantageous for the controller of the apparatus to trigger a cancellation of the gripping effect one row at a time. Therefore, in the case of clamping devices, a pair of clamping plates are moved apart in order to release the row of packages that was clamped between them. In the case of suction devices, the negative pressure is cancelled in one row of suction elements. Preferably, this first activated row of suction or clamping elements runs essentially along the transport direction of the conveyor belt 80, so that the packages are put down in the lengthwise direction with respect to the direction of transport. The adjacent rows of gripping elements are released one after the other.

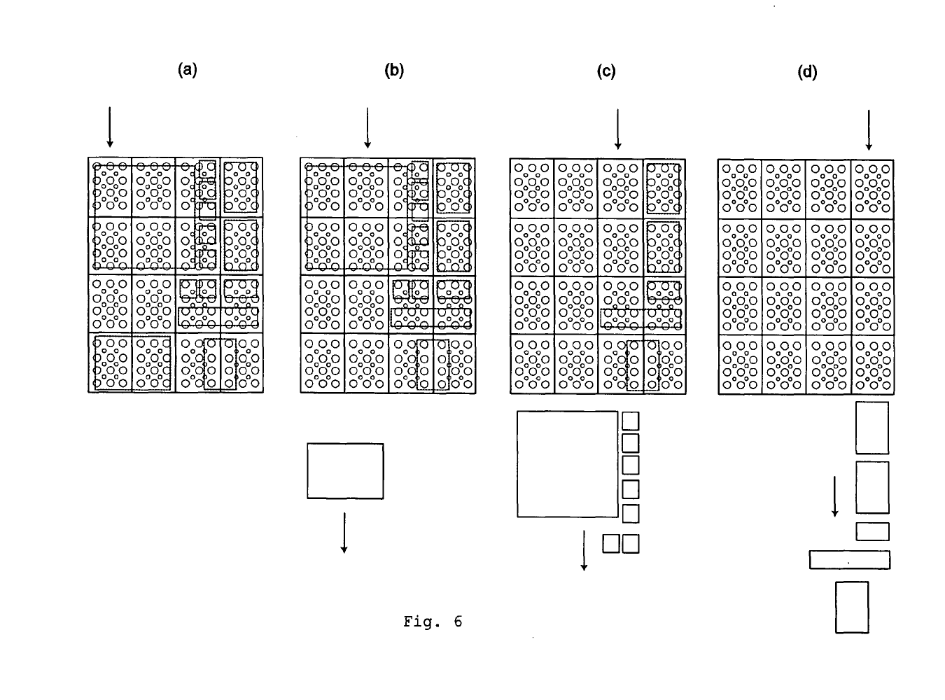

This scheme involving the cancellation of the negative pressure of the suction devices one row at a time is depicted in FIG. 6, whereby the particular row being vented and the transport of packages on a conveyor belt are indicated by an arrow. The scheme can be employed analogously in the case of the clamping elements.

In step (a), the outer left-hand row of suction devices is vented that extends along the direction of transport of the conveyor belt. Since two large packages that are also being held by suction devices of the second row are hanging on this row, the packages presumably will not drop yet. As soon as the second row is vented in step (b), the smaller of the two packages is no longer held and drops onto the baffle plate. Even though the larger of the packages is still being held by suction devices of the third row, owing to its weight, it could already drop as well. However, at the latest in step (c), the large package drops together with several smaller packages during the venting of the third row. In step (d), the remaining packages drop from the fourth row onto the conveyor belt or baffle plate.

Consequently, the packages fall either individually or in groups onto the baffle plate, but are then transported away by the conveyor belt individually and essentially one after the other. In order to prevent packages that are in the back of the conveying device from being blocked by larger packages hanging in front of them if the larger packages do not drop until later during the venting of the next row, the height of the gripping device during the placement procedure is preferably selected in such a way that packages that drop onto the baffle plate from the back can slide underneath packages hanging in front of them.

In order to allow pallets with different packaged goods to be unloaded, it is not only possible to change the gripping device, but also to vary the scheme when the gripping effect of the individual gripping elements is cancelled. For example, an operator can use an operating menu to enter the type of packaged goods and especially the dimensions of the packaged goods present on a given pallet. The actuation of the gripping elements is then adapted accordingly. For instance, in the case of smaller packaged goods, the smallest sections with gripping elements are actuated, whereas in the case of larger packaged goods, the actuation of larger sections is sufficient in order to allow the objects to be put down sequentially.

The cancellation of the negative pressure of a row with suction devices 21 is synchronized according to the advance movement of the conveyor belt 80. For this purpose, the conveying speed of the conveyor belt can be entered manually into a menu by an operator, for example, prior to starting up the pallet-emptying unit, or else the conveying speed of the belt is adjusted to the cycle time of the pallet-emptying unit.

The distance between the gripping device 20 and the baffle plate 40 should be selected in such a manner that the packages are not damaged when they are released. Optionally, after the horizontal movement, the articulated-arm robot 30 can once again move the gripping device 20 vertically downwards in order to compensate for an excessive height difference.

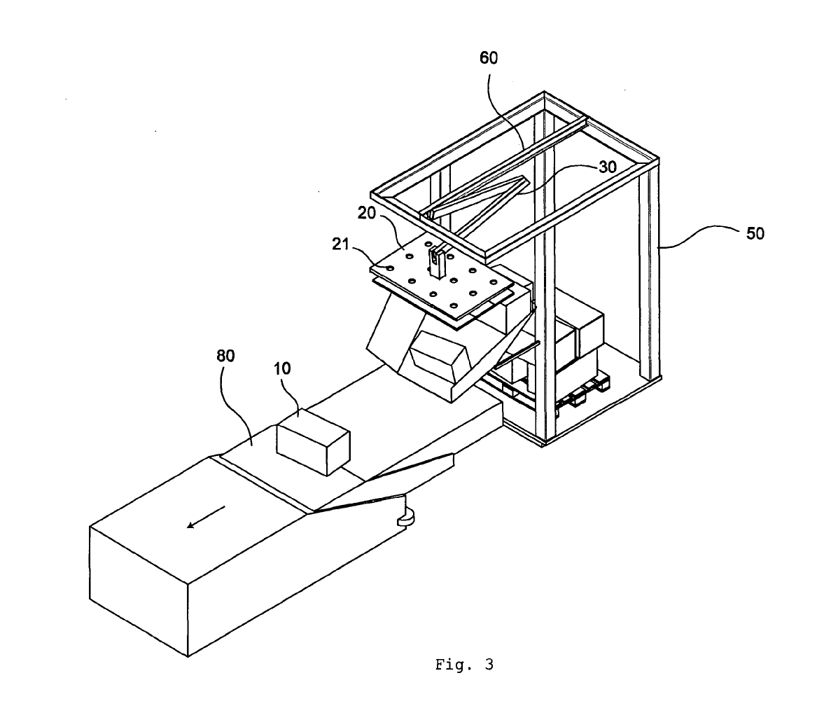

The packages then slide individually over the baffle plate onto the conveyor belt 80 and are thus transferred to this second position Y. If the baffle plate is configured with side walls that run towards each other in a funnel-like fashion, the packages are also steered towards the center of the conveyor belt. The packages are transported away by the conveyor belt one after the other, as shown in FIG. 3.

Once all of the suction devices have been vented, the gripping device is moved once again into position X above the pallet 11 and the procedure starts anew. If, due to their small size, individual packages have remained in the upper layer of the package stack, they are now picked up and transferred onto the baffle plate 40. Therefore, the apparatus always transfers the packages whose top can be picked up by suction, until all of the packages have been removed from the pallet. For this purpose, even though the apparatus has to carry out a large number of transfer operations during the pallet-emptying procedure, this does not require complicated sensor technology in order to determine the number and position of the packages before or during the pick-up procedure.

As soon as all of the packages have been removed from the pallet 11 and the gripping device has once again been lowered above the now empty pallet, this condition is detected by a sensor and no additional suction procedure is carried out. This can be achieved, for example, in such a manner that a sensor is provided at a small distance above the pallet and it detects when the gripping device has been lowered below this defined height and then sends a signal to the apparatus to the effect that no more packages are present to be picked up and the transfer procedure can be terminated. This sensor can be, for instance, a light barrier.

In another exemplary embodiment, a light bather constantly scans the surface of the pallet and it generates a signal as soon as no more objects are detected on the pallet. In this case, the pallet-emptying procedure is halted before the gripping device could be lowered again onto the empty pallet. As an alternative, the drive itself can be provided with a sensor that detects when the gripping device has been lowered below a defined height and thus interrupts the transferring procedure.

As soon as the unloading procedure has been ended, the apparatus can generate an acoustical and/or visual signal in order to indicate to the operator that an empty pallet can be removed. After a new pallet with packages has been put in place, the procedure is started anew. Once all of the pallets for the destination of the conveyor belt have been emptied, the pallet-emptying unit can be transported to another conveyor belt and used there.

In another exemplary embodiment of the invention, the gripping device 20 can be additionally rotated around a vertical axis so that packages can be picked up from a pallet inside the housing 50 and put down on two or more sides of the apparatus. In this manner, packages can be placed alternately onto two different conveyor belts without the pallet-emptying unit having to be repositioned.

### LIST OF REFERENCE NUMERALS

10 packaged goods, package
11 transporting device, carrier device, pallet, container
20 gripping device
21 suction device
22 suction opening
30 drive, articulated-arm robot
40 guide element, baffle plate
41 bottom plate of the baffle plate
42, 42′ side wall of the baffle plate
50 housing; gantry
60 rail
70 baseplate
71 forklift slot
81 conveyor belt

1-28. (canceled)

29. An apparatus for transferring packaged goods from a first position X to a second position Y, comprising:
at least one gripping device comprising several gripping elements of which at least two can be actuated separately from each other;
a drive that is adapted to move the at least one gripping device in a vertical direction and in at least one horizontal direction;
a controller that is configured according to a fixed scheme, the controller being adapted to sequentially cancel a gripping effect of the gripping elements; and
a guide element adapted to steer the packaged goods to the second position Y, the guide element comprising a baffle plate placed in a slanted position and having a bottom plate and two side walls that run towards each other in the form of a funnel.

30. The apparatus recited in claim 29, wherein the gripping device comprises at least two rows, each consisting of at least two gripping elements, and wherein the controller is configured to cancel a gripping effect of the gripping elements one row at a time.

31. The apparatus recited in claim 29, wherein the gripping elements comprise clamping devices with which the packaged goods can be picked up, whereby the clamping effect of the clamping devices can be cancelled sequentially.

32. The apparatus recited in claim 29, wherein the gripping elements comprise suction devices of which at least two are connected separately from each other to a source of negative pressure, and wherein the controller is adapted to sequentially cancel the negative pressure in the suction devices.

33. The apparatus recited in claim 29, wherein the drive is located inside a housing that is arranged above the first position X.

34. The apparatus recited in claim 33, wherein the housing is constructed in the form of a gantry structure using at least two essentially vertical side struts and an upper cross strut.

35. The apparatus recited in claim 33, wherein the housing is formed by four essentially vertical side struts arranged in a rectangle and four upper cross struts that connect the side struts.

36. The apparatus recited in claim 29, wherein the drive comprises an articulated-arm robot that is installed on a housing.

37. The apparatus recited in claim 36, wherein the articulated-arm robot is adapted to be moved in a horizontal direction on a rail.

38. The apparatus recited in claim 37, wherein the rail is attached to at least one upper cross strut of the housing.

39. The apparatus recited in claim 29,wherein the drive is located inside a housing that is arranged above the first position X, and wherein the second position Y is located outside of the housing.

40. The apparatus recited in claim 29, wherein the drive is located inside a housing that is arranged above the first position X, and wherein the guide element is attached to the housing and is located outside of the housing.

41. The apparatus recited in claim 29, wherein the apparatus is mounted on a movable baseplate.

42. The apparatus recited in claim 41, wherein the baseplate has fixtures into which a transporting device can be inserted.

43. The apparatus recited in claim 42, wherein the fixtures into which a transporting device can be inserted comprise forklift slots.

44. The apparatus recited in claim 29, comprising an alignment device that, in the first position X, aligns a carrier on which the packaged goods are positioned in order to be picked up.

45. A method for transferring packaged goods from a first position X to a second position Y, the method comprising:
picking up the package goods at the first position X using a gripping device that comprises several gripping elements that are moved by a drive in a vertical direction and in at least one horizontal direction to the second position Y;
moving the packaged item to the position Y above a guide element in order to steer the packaged goods to the second position Y, the guide element comprising a slanted a baffle plate having a bottom plate and two side walls that run towards each other in the form of a funnel;
actuating, at the second position Y, at least two of the gripping elements separately from each other; and
sequentially canceling a gripping effect of the gripping elements according to a fixed scheme.

46. The method recited in claim 45, wherein the gripping device comprises at least two rows, each comprising at least two gripping elements, the method comprising canceling the gripping effect of the gripping elements one row at a time.

47. The method recited in claim 46, wherein the at least two rows extend in the transportation direction of a conveyor belt, the method comprising starting the cancellation of the gripping effect of the gripping elements in an outer row.

48. The method recited in claim 45, comprising synchronizing the canceling of the gripping effect of the gripping elements with an advance movement of a conveyor belt.

49. The method recited in claim 45, wherein the gripping elements comprise clamping devices with which the packaged goods are picked up, the method comprising sequentially canceling a clamping effect of the clamping devices.

50. The method recited in claim 45, wherein the gripping elements comprise suction devices of which at least two are connectedly separately from each other to a source of negative pressure, the method comprising sequentially canceling the negative pressure in the suction devices.

51. The method recited in claim 45, wherein the packaged item is moved by the drive to the position Y above a conveyor belt.

52. An apparatus for transferring packaged goods from a first position X to a second position Y, comprising:
means for gripping comprising several gripping elements of which at least two can be actuated separately from each other;
means for driving is adapted to move the means for gripping in a vertical direction and in at least one horizontal direction;
means for controlling configured according to a fixed scheme, the means for controlling being adapted to sequentially cancel a gripping effect of the gripping elements; and
means for guiding adapted to steer the packaged goods to the second position Y, the means for guiding comprising a baffle plate placed in a slanted position and having a bottom plate and two side walls that run towards each other in the form of a funnel.
